(19) United States
(12) Patent Application Publication
(10) Pub. No.: US 2018/0318788 A1
(43) Pub. Date: Nov. 8, 2018

(54) METHOD FOR REMOVAL OF FLUORINATED ORGANICS FROM BYPRODUCT ANHYDROUS OR AQUEOUS HYDROCHLORIC ACID IN THE 1234YF VIA 1230XA PROCESS

(71) Applicant: HONEYWELL INTERNATIONAL INC., Morristown, NJ (US)

(72) Inventors: Richard Durick HORWATH, Morris Plains, NJ (US); Yuon CHIU, Morris Plains, NJ (US); Haluk KOPKALLI, Morris Plains, NJ (US); Robert A. SMITH, Morris Plains, NJ (US); Haiyou WANG, Morris Plains, NJ (US); Michael GATTER, Morris Plains, NJ (US); Hsueh Sung TUNG, Morris Plains, NJ (US); Daniel C. MERKEL, Morris Plains, NJ (US)

(73) Assignee: HONEYWELL INTERNATIONAL INC., Morristown, NJ (US)

(21) Appl. No.: 15/773,769

(22) PCT Filed: Nov. 4, 2016
(86) PCT No.: PCT/US2016/060602

§ 371 Date: May 4, 2018

Related U.S. Application Data
(60) Provisional application No. 62/251,438, filed on Nov. 5, 2015.

(51) Int. Cl. B01J 20/10; B01J 20/20; B01J 20/18; C02F 1/28

(52) U.S. Cl. CPC B01J 20/103; B01J 20/20; C02F 2101/14; C02F 1/281; C02F 1/283; B01J 20/18

(57) ABSTRACT

Disclosed is a process to separate halogenated organic contaminants such as 2-chloro-3,3,3-trifluoropropene (HCFO-1233xf), 2,3,3,3-tetrafluoropropene (HFO-1234yf), trifluoropropyne (TFPY) from hydrochloric acid (HCl) with an adsorbent selected from an activated carbon, an MFI molecular sieve, a carbon molecular sieve, silica, and combinations thereof.

### FIELD OF THE INVENTION

The invention provides a method of removing halogenated organic compounds, especially fluorinated propylenes and/or propynes—such as 2-chloro-3,3,3-trifluoropropene (HCFO-1233xf), 2,3,3,3-tetrafluoropropene (HFO-1234yf), and trifluoropropyne (TFPY)—from hydrochloric acid (HCl). In one practice, select molecular sieves, including Carbon Molecular Sieves (CMS) are employed to remove the fluorinated organics. In another practice, the method provides high purity, commercial grade, including food grade, HCl solution which can be sold as such.

### BACKGROUND OF THE INVENTION

Hydrofluoroolefins (HFOs), such as tetrafluoropropenes, including 2,3,3,3-tetrafluoropropene (HFO-1234yf), are known to be effective refrigerants, heat transfer media, propellants, foaming agents, blowing agents, gaseous dielectrics, sterilant carriers, polymerization media, particulate removal fluids, carrier fluids, buffing abrasive agents, displacement drying agents and power cycle working fluids. Unlike chlorofluorocarbons (CFCs) and hydrochlorofluorocarbons (HCFCs), both of which potentially damage the Earth's ozone layer, HFOs pose no threat to the ozone layer. HFO-1234yf has also been shown to be a low global warming compound with low toxicity and, hence, can meet increasingly stringent requirements for refrigerants in mobile air conditioning. Accordingly, compositions containing HFO-1234yf are among the materials being developed for use in many of the aforementioned applications.

One manufacturing process for HFO-1234yf uses 1,1,2,3-tetrachioropropene (1230xa) as starting raw material. The process comprises the following three steps:
Step (1) 1230xa+3HF-->2-chloro-3,3,3,-trifluoropropene (1.233xf)+3HCl in a vapor phase reactor charged with a solid catalyst;
Step (2) 1233xf HF-->2-chloro-1,1,1,2-tetrafluoropropane (244bb) in a liquid phase reactor charged with a liquid catalyst; and
Step (3) 244bb-->1234yf HCl in a vapor phase reactor.

In each of Steps (1) and (3), significant amounts of HCl are generated as byproduct. It is desirable to recover this HCl byproduct so that it can be sold. However, these HCl. byproducts may be contaminated with fluorinated organic compounds. These include fluorinated propenes and propynes, such as 1233xf (2-chloro-3,3,3-trifluoropropene), 1234yf (2,3,3,3-tetrafluoropropene), and TFPY (3,3,3-trifluoropropyne). Specifications for high purity HCl typically limit the fluorinated organic content to a small value, e.g. 25 ppm by weight in a 22 Baume solution (35.5-36 wt % aqueous HCl).

Conventionally, recovery of HCl is accomplished via distillation whereby anhydrous HCl is endeavored to be separated from fluorinated organics. This is optionally followed by absorbing the resultant HCl into water with the intent to form a saleable solution of HCl. However, if anhydrous HCl recovery efforts do not sufficiently reduce the fluorinated organic content, the resulting HCl solution from absorption in water can contain these fluorinated organics, due to their solubility in water, at ppm levels that may not meet the specifications aforesaid and is hence unacceptable for sale as high purity or food grade HCl. Additionally, TFPY is toxic, hence its removal is all the more important.

There is thus a need for an improved process to separate HCl from these contaminants, including to produce high purity HCl solution for sale.

### SUMMARY OF THE INVENTION

In one aspect, the invention is a separation process that comprises contacting a composition comprising hydrochloric acid (HCl) and halogenated organic compounds such as 2-chloro-3,3,3-trifluoropropene (HCFO-1233xf), 2,3,3,3-tetrafluoropropene (HFO-1234yf), trifluoropropyne (TFPY), and mixtures thereof with an adsorbent selected from an activated carbon, an MFI molecular sieve, a carbon molecular sieve, silica, and combinations thereof, under conditions effective to separate the HCl from these organic compounds, especially TFPY. In one embodiment, the HCl that is separated can be absorbed into water to form an aqueous solution; as known in the art, the concentrations of HCl aqueous solutions are measured on the Baume scale. In an embodiment of the present invention, separated HCl can be absorbed into water to form aqueous solutions of about 7 to about 23 Baume, including preferably about 20 to about 23 Baume, and including more preferably about a 22 Baume solution. (as known in the art, a 22 Baume HCl solution is an aqueous HCl solution where HCl is present at about 35.5-36 wt %). High purity HCl solutions, e.g. 22 Baume, are saleable as food grade.

The invention can be practiced on anhydrous HCl compositions, or on aqueous HCl compositions where removal of contaminants is needed. In a prefenred embodiment, contaminant components such as, without limitation, 1234yf, 1233xf, and TFPY, are present at levels ranging from about 50 to about 5000 ppm by weight in the composition with HCl; one or more of these contaminants are then removed to provide a resulting HCl solution wherein at least one of the contaminant components is present at levels of about 25 ppm or less, preferably about 20 ppm or less, more preferably about 15 ppm or less, and still more preferably about 10 ppm or less, and yet more preferably about 5 ppm or less, and still yet more preferably about 2 ppm or less. In another embodiment of the invention, the concentration of at least one of the contaminant components is reduced in the HCl solution by about 50% or more, preferably about 75% or more, more preferably about 90% or more, and still more preferably about 95% or more.

The invention has applicability without limitation to Steps (1) and (3) of the process to make HFO-1234yf with 1,1,2,3-tetrachioropropene (1230xa).

### BRIEF DESCRIPTION OF THE DRAWINGS

FIGS. 1A and 1B are schematic process flow charts depicting embodiments of the invention having impurity removal systems respectively for Steps (1) and (3) in the manufacture of 1234yf using 1230xa.

FIG. 2 is a schematic process flow chart depicting an embodiment of the invention having a single, combined impurity removal system for Steps (1) and (3) in the manufacture of 1234yf using 1230xa.

FIGS. 3A and 3B are schematic process flow charts depicting an alternative embodiments of the invention from that shown in FIGS. 1A and 1B respectively.

FIG. 4 is a schematic process flow chart depicting an alternative embodiment of the invention from that shown in FIG. 2.

### DETAILED DESCRIPTION OF THE INVENTION

The entire contents of U.S. Pat. No. 8,058,486, which discloses an integrated process to produce 2,3,3,3-tetrafluoropropane (HFO-1234yf), are incorporated herein. The present process relates to a means of isolating HCl from intermediates or the final product in a process of preparing HFO-1234yf. The operations described hereunder may be carried out in continuous, semi-continuous, or batch processes, or of any combinations thereof.

As explained hereinbelow, in an embodiment, the present process comprises a separation process comprising contacting a composition comprising hydrochloric acid (HCl) and 2,3,3,3-tetrafluoropropene (HFO-1234yf) with an adsorbent selected from activated carbon, MFI molecular sieve, carbon molecular sieve, silica, and combinations thereof, under conditions effective to separate the HFO-1234yf from the HCl. The adsorbent in one embodiment is activated carbon. In another embodiment, the activated carbon is obtained from coconut shell based activated carbon, coal based activated carbon, or combinations thereof. In another embodiment, the activated carbon used in the present disclosure is manufactured by the reactivation of previously used activated carbon by techniques known in the art. In an embodiment, the activated carbon utilized is retained on about a 50 mesh sieve. The activated carbon can be in powdered, granular or extruded form. The adsorption capacity of the activated carbon can be improved by removing ash content of the carbon by, e.g., an acid wash as known in the art. In certain embodiments, the activated carbon is designed by the manufacturer for use in vapor phase applications. In certain embodiments, the activated carbon is designed by the manufacturer for use in vapor phase applications. In certain embodiments, the activated carbon is designed by the manufacturer for use in liquid phase applications. Calgon Carbon Corporation of Pittsburgh, Pa. manufactures and sells a number of such activated carbons useful in the present process, including products having the following designations: CPG, PCB, OLC, BPL, RVG, OVC, COCO, AT-410, and VPR, as examples. One parameter used to characterize activated carbons useful in the present process is the Iodine Number. The Iodine Number is generally used as a measure of activity level, a higher number indicates a higher degree of activation, and it also serves as an indicator of the micropore content of the activated carbon. The Iodine Number is defined as the milligrams of iodine adsorbed by one gram of carbon when the iodine concentration in the residual filtrate is 0.02 normal. In one practice of the present invention, activated carbons having a minimum Iodine Number of about 900 are employed; in another practice, the activated carbons have a minimum Iodine Number of about 950; in another embodiment, the activated carbon has a minimum Iodine Number of about1000; in another practice, the activated carbons have a minimum Iodine Number of about 1050; in another embodiment, the activated carbon has a minimum Iodine Number of 1100; in another practice, the activated carbons have a minimum iodine Number of 1150; in a still another embodiment, the activated carbon has a minimum Iodine Number of 1200. In an embodiment, the iodine number of the activated carbon may be as high as about 1300, although in other embodiments, it may be as high as about 1200. Thus, in an embodiment, the iodine number of the activated carbon used herein may have an iodine number ranging from about 900 to about 1300. If activated carbon is used directly on the HCl aqueous solution, in an embodiment, the activated carbon can be pretreated with acid as is known in the art; such pretreatment will among other things ameliorate contamination issues with color leaching. In an embodiment, the activated carbon used is a granular activated carbon which is acid washed having an iodine number of 950 or more and a pH ranging from about 5.0 to about 8.0. It may further have a moisture content of at most 3% by weight. In addition, it may have acid soluble ash in an amount of at most 0.5 wt % and acid soluble iron of at most 0.01 wt %. The activated carbon may also have a minimum molasses number of 200. As used herein, the molasses number is a measure of the mesopore content of the activated carbon by adsorption of molasses from solution. The higher the molasses number signifies a higher amount of adsorption of larger molecules. In an embodiment, the activated carbon has a 10 US mesh (2.00 mm) of a maximum of 5 wt % and a maximum of 0.5 wt % of less than 40 US mesh (0.425 mm). In another embodiment, it has a minimum abrasion number of 78. As used herein, the abrasion number refers to a carbon's ability to withstand attrition, i.e., the ability to maintain the physical integrity. Thus it is a measure of hardnes; the higher the abrasion number, the more resistant the activated carbon is to abrasion. In an embodiment, the activated carbon used herein has more than two of the characteristics described in this paragraph, while in another embodiment, it has at least three of the characteristics described in this paragraph, while in another embodiment, it has all of the characteristics described in this paragraph.

In another embodiment, the adsorbent is silica or molecular sieves. Molecular sieves, such as without limitation, zeolites, are serviceable in the practice of the invention and include without limitation those known in the art by the denominations 5A, AW 500, 10X, and 13X; and including without limitation ZSM zeolites such as ZSM-5, H-ZSM-5, MFI or silicalite (an A1-free version of ZMS-5); and combinations of any of the foregoing. In an embodiment, the molecular sieve is silicalite. In an embodiment, the molecular sieves can be activated by calcining optionally followed by an acid wash, as known in the art. In one practice of the invention, molecular sieves having pore sizes of 5 Å or greater are utilized.. In another embodiment, the pore size is 5 Å to 10 Å. In a still further embodiment, the pore size is 5 Å to 6 Å. The molecular sieves may optionally be subject to drying by heat and or inert gas purge prior to use as known in the art.

Carbon molecular sieves are a class of activated/porous carbons that have large surface areas with a fairly uniform micropore size capable of selective absorption. They are derived from natural materials such as coal or from man-made polymers such as discussed in U.S. Pat. Nos. 4,820,681 and 6,670,304 and US Publication No. 2002/0025290. Carbon molecular sieves are commercially available and those serviceable in the practice of the invention include without limitation Shirasagi X2M4/6, MSC 3K-172 (supplied by Japan EnviroChemicals) and CMS H255/2, CT-350, CMS 112-10 (supplied by CarboTech; Geiniany). In one practice, carbon molecular sieves having average pore sizes of 5 Å or greater are preferred.

Different adsorbent materials can be used in various combinations, e.g. different adsorbent materials can be used in successive beds. By way of example only, if the HCl is contaminated with trace (ppm) levels of 1233xf, TFPY, and 1234yf, then a first adsorbent bed can be packed with less expensive adsorbent material, such as activated carbon, for the bulk removal of 1233xf, TFPY, and 1234yf, followed by one or more subsequent beds of, for example, carbon molecular sieve material to obtain more selective adsorption.

The present process is exemplified by referring to the figures.

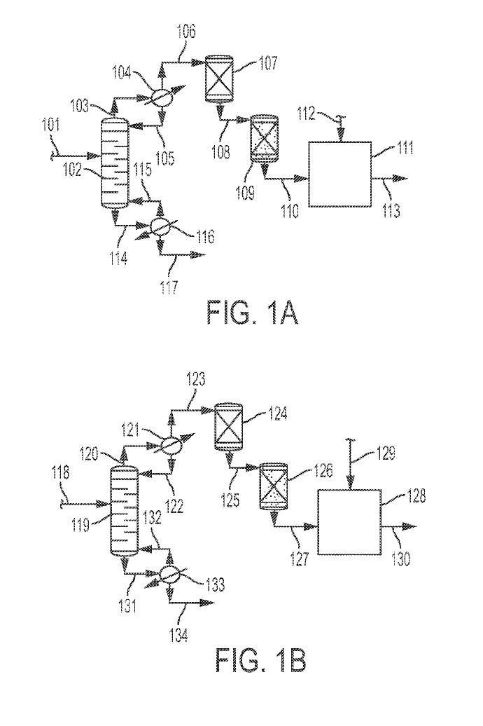

FIGS. 1A and 1B together depict an embodiment of the invention wherein the HCl byproducts of Steps (1) and (3) of the three-step process to manufacture 1234yf from 1230xa are independently processed. In these practices, anhydrous HCl is flowed through the adsorption media according to the invention. Whereas the process of the invention is described in terms of a continuous process flow, it is understood that the process can be batch, or semi-continuous, in addition to continuous, or combinations of these.

FIG. 1A illustrates a practice of the invention as applied to removing halogenated impurities from anhydrous HCl formed from Step (1). In FIG. 1A, the HCl byproduct stream 101 from Step (1) comprises HCl, HF, various halogenated organic compounds in minor amounts, e.g. typically about 50 ppm to about 5000 ppm, including without limitation 1232xf, 1234yf, 244bb, 245cb and also 1233xf which makes up most of the contaminating organics in stream 101. Stream 101 is sent to HO distillation column 102 which can comprise a series of such columns, and the overhead 103 is sent to HCl column condenser 104. The bottom liquid reflux 105 from condenser 104 is recycled to column 102 and the top vapor stream 106 is sent to silica gel tower 107. The bottoms 114 from distillation column 102 is sent to HCl column reboiler 116, the top stream from which 115 is recycled back to column 102, and the bottom stream from which 117 is essentially free of HCl but contains various organics which can be sent for further processing, including recovery (not shown). Silica gel tower 107 can be a single tower or multiple towers in series or parallel. Tower 107, the use of which is optional in the practice of the present invention, principally removes trace HF still present in stream 106. Silica gels useful in this regard include without limitation A-Type, B-Type, C-Type, and stabilizing silica gels. Effluent 108 from tower 107 is sent to adsorbent bed 109, which can be a single adsorbent bed or multiple beds in series or parallel. Use of multiple beds allows for online changing of adsorption media once it is spent. Spent media can be changed out or regenerated using methods known in the art, including in a countercurrent manner. The adsorption of the halogenated organics that occurs in 109 can be vapor phase adsorption or liquid phase adsorption. For practices where the HCl is anhydrous, vapor phase adsorption is preferred; for practices where the HCl is aqueous, liquid phase adsorption is preferred. In one practice, adsorption of anhydrous HCl is preferred to reduce material of construction costs which are due to the corrosivity of aqueous HCl to various metals.

Adsorbent bed 109 can comprise materials such as without limitation activated carbons, molecular sieves, including zeolites and MFI molecular sieves such as silicalite, carbon molecular sieves, and combinations thereof.

Conditions at which adsorbent bed 109 is operated at can vary; in one practice, the contacting temperature of bed 109 is about −20° C. to about 200° C.; in other practices, the temperature is about 0° C. to about 100° C.; about 10° C. to about 60° C.; and about 25° C. or room temperature. In one practice, pressure is not critical, but can be about 10 kPa to about 3000 kPa. The conditions are effective for the adsorbent to remove sufficient amounts of fluorinated organics such as 1233xf, 1234yf and TFPY such that the HCl effluent 110 can be sent to the HCl absorption system 111 to which water 112 is fed to produce an aqueous HCl solution 113 that meets specifications stipulated for sale as high purity or food grade HCl solution, including as a 22 Baume solution.

FIG. 1B illustrates a practice of the invention as applied to removing halogenated impurities from anhydrous HCl formed from Step (3). The scheme is similar to FIG. 1A. The HCl byproduct stream, 118, from Step (3) comprises HCl, minor amount of HF, various halogenated organic compounds also in minor amounts including without limitation TFPY, 1233xf, 244bb, 245cb and including 1234yf which makes up most of the contaminating organics in stream 118.

Stream 118 is sent to HCl distillation column 119 which can comprise a series of such columns, and the overhead 120 is sent to HCl column condenser 121. The bottom liquid reflux 122 from condenser 121 is recycled to column 119 and the top vapor stream 123 is sent to silica gel tower 124. The bottoms 131 from distillation column 119 is sent to HCl column reboiler 133, the top stream from which 132 is recycled back to column 119, and the bottom stream from which 134 is essentially free of HCi but contains various organics which can be sent for further processing, including recovery (not shown). Silica gel tower 124 can be a single tower or multiple towers in series or parallel. Tower 124, the use of which is optional in the practice of the present invention, principally removes trace HF still present in stream 123. Silica gels useful in this regard are as above. Effluent 125 from tower 124 is sent to adsorbent bed 126, which can be a single adsorbent bed or multiple beds in series or parallel.

Adsorbent bed 126 can comprise materials such as without limitation activated carbons, molecular sieves, including zeolites and MFI molecular sieves such as silicalite, carbon molecular sieves, and combinations thereof, as above. The operating conditions for bed 126 are also as above. The conditions are effective for the adsorbent to remove sufficient amounts of fluorinated organics such as 1233xf, 1234yf and TYPY such that the HCl effluent 127 can be sent to the HCl absorption system 128 to which water 129 is fed to produce an aqueous HCl solution 130 that meets specifications stipulated for sale as high purity or food grade HCl, including as a 22 Baume solution.

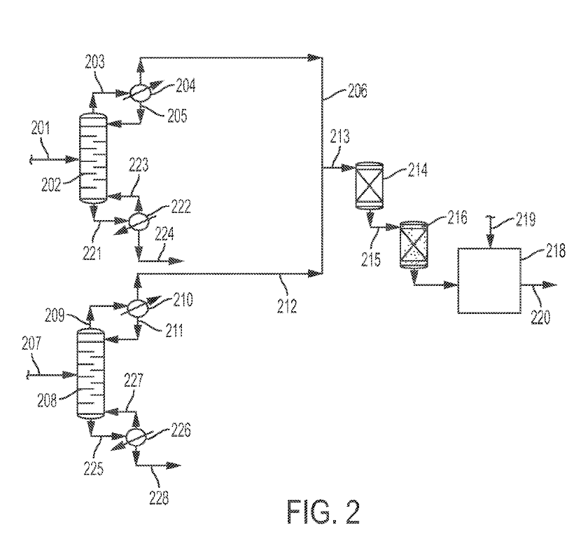

FIG. 2 illustrates a practice wherein the anhydrous HCl byproduct streams from Steps (1) and (3) are combined and then the anhydrous HCl is processed according to the invention. In FIG. 2, the HCl byproduct stream 201 from Step (1) comprises HCl, HF, various halogenated organic compounds in minor amounts including without limitation 1232xf, 1234yf, 244bb, 245cb and also 1233xf which makes up most of the contaminating organics in stream 201. Stream 201 is sent to HCl distillation column 202 which can comprise a series of such columns, and the overhead 203 is sent to HCl column condenser 204. The bottom liquid reflux 205 from condenser 204 is recycled to column 202. The bottoms 221 from distillation column 202 is sent to HCl column reboiler 222, the top stream from which 223 is recycled back to column 202, and the bottom stream from which 224 is essentially free of HCl but contains various organics which can be sent for further processing, including recovery (not shown). Similarly, the HCl byproduct stream 207 from Step (3) comprises HCl, minor amount of HF, various halogenated organic compounds also in minor amounts including without limitation TFPY, 1233xf, 244bb, and including 1234yf which makes up most of the contaminating organics in stream 207. Stream 207 is sent to HCl distillation column 208 which can comprise a series of such columns, and the overhead 209 is sent to HCl column condenser 210. The bottom liquid reflux 211 from condenser 210 is recycled to column 208. The bottoms 225 from distillation column 208 is sent to HCl column reboiler 226, the top stream from which 227 is recycled back to column 208, and the bottom stream from which 228 is essentially free of HCl but contains various organics which can be sent for further processing, including recovery (not shown).

Streams 206 and 212 coming respectively from condensers 204, associated with Step (1), and 210, associated with Step (3), are combined to form stream 213 which is fed to silica gel tower 214. Silica gel tower 214 can be a single tower or multiple towers in series or parallel. Tower 214, the use of which is optional in the practice of the present invention, principally removes trace HF still present in combined stream 213. Silica gels useful in this regard are as above. Effluent 215 from tower 214 is sent to adsorbent bed 216, which can be a single adsorbent bed or multiple beds in series or parallel. Adsorbent bed 216 can comprise materials such as without limitation activated carbons, molecular sieves, including zeolites and MFI molecular sieves such as silicalite, carbon molecular sieves, and combinations thereof, as above. The operating conditions for bed 216 are also as above. The conditions are effective for the adsorbent to remove sufficient amounts of fluorinated organics such as 1233xf, 1234yf and. TYPY such that the HCl effluent 217 can be sent to the HCl absorption system 218 to which water 219 is fed to produce an aqueous HCl solution 220 that meets specifications stipulated for sale as high purity or food grade HCl solution, including as a 22 Baume solution.

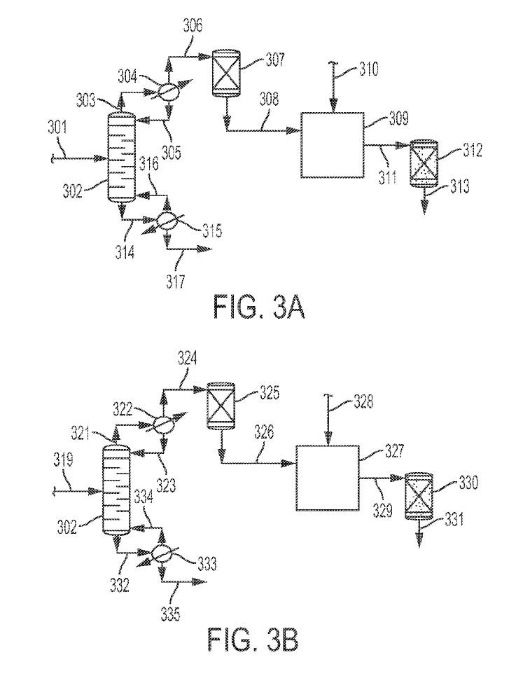

FIGS. 3A and 3B together depict another embodiment of the invention wherein the HCl products of Steps (1) and (3) of the three-step process to manufacture 1234yf from 1230xa are independently processed according to the invention. In these practices, aqueous HCl is flowed through the adsorption media according to the invention.

In FIG. 3A, the anhydrous HCl byproduct stream 301 from Step (1) comprises HCl, HF, various halogenated organic compounds in minor amounts including without limitation 1232xf, 1234yf, 244bb, 245cb and also 1233xf which makes up most of the contaminating organics in stream 301. Stream 301 is sent to HCl distillation column 302 which can comprise a series of such columns, and the overhead 303 is sent to HCl column condenser 304. The bottom liquid reflux 305 from condenser 304 is recycled to column 302 and the top vapor stream 306 is sent to silica gel tower 307. The bottoms 314 from distillation column 302 is sent to HCl column reboiler 315, the top stream from which 316 is recycled back to column 302, and the bottom stream from which 317 is essentially free of HCl but contains various organics which can be sent for further processing, including recovery (not shown).

Silica gel tower 307 can be a single tower or multiple towers in series or parallel. Tower 307, the use of which is optional in the practice of the present invention, principally removes trace HF still present in stream 306. Silica gels useful in this regard are as above. Effluent 308 from tower 307 is sent to HCl absorption system 309 to which water 310 is fed. Effluent 311, comprising aqueous HCl, is then sent to adsorbent bed 312, which can be a single adsorbent bed or multiple beds in series or parallel. Adsorbent bed 312 can comprise materials such as without limitation activated carbons, molecular sieves, including zeolites and MFI molecular sieves such as silicalite, carbon molecular sieves, and combinations thereof, as above. When removing the halogenated organics from aqueous HCl, it is preferred that the adsorption media be comprised of carbon molecular sieves. The operating conditions for bed 312 are also as above. The conditions are effective for the adsorbent to remove sufficient amounts of fluorinated organics such as 1233xf, 1234yf and TFPY such that the HCl effluent 313 meets or can be further treated to meet specifications stipulated for sale as high purity or food grade HCl solution, including as a 22 Baume solution.

FIG. 3B illustrates another practice of the invention as applied to removing halogenated impurities from anhydrous HCl formed from Step (3). The scheme is similar to FIG. 3A. The HCl byproduct stream, 319 from Step (3) comprises HCl, minor amount of HF, various halogenated organic compounds also in minor amounts including without limitation TFPY, 1233xf, 244bb, and including 1234yf which makes up most of the contaminating organics in stream 319. Stream 319 is sent to HCl distillation column 320 which can comprise a series of such columns, and the overhead 321 is sent to HCl column condenser 322. The bottom liquid reflux 323 from condenser 322 is recycled to column 320 and the top vapor stream 324 is sent to silica gel tower 325. The bottoms 332 from distillation column 320 is sent to HCl column reboiler 333, the top stream from which 334 is recycled back to column 320, and the bottom stream from which 335 is essentially free of HCl but contains various organics which can be sent for further processing, including recovery (not shown).

Silica gel tower 325 can be a single tower or multiple towers in series or parallel. Tower 325, the use of which is optional in the practice of the present invention, principally removes trace HF still present in stream 324. Silica gels useful in this regard are as above. Effluent 326 from tower 325 is sent to HCl absorption system 327 to which water 328 is fed. Effluent 329, comprising aqueous HCl, is then sent to adsorbent bed 330, which can be a single adsorbent bed or multiple beds in series or parallel. Adsorbent bed 330 can comprise materials such as without limitation activated carbons, molecular sieves, including zeolites and MFI molecular sieves such as silicalite, carbon molecular sieves, and combinations thereof, as above. The operating conditions for bed 330 are also as above. The conditions are effective for the adsorbent to remove sufficient amounts of fluorinated organics such as 1233xf, 1234yf and TFPY such that the HCl effluent 331 meets or can be further treated to meet specifications stipulated for sale as high purity or food grade HCl solution, including as a 22 Baume solution.

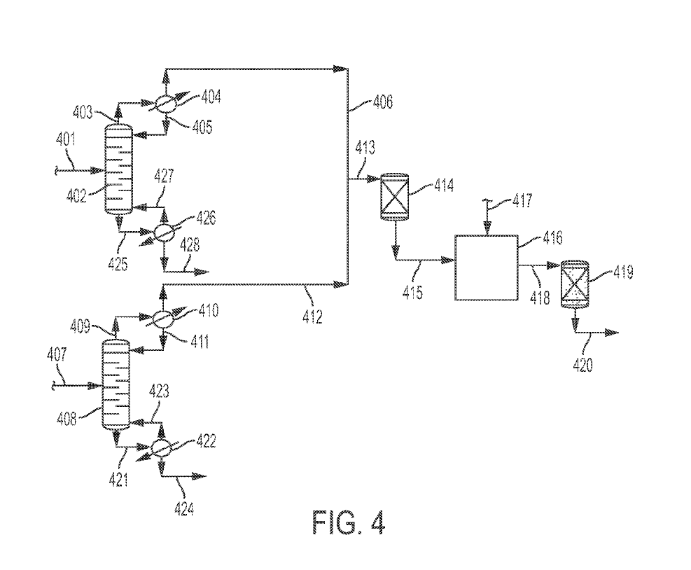

FIG. 4 illustrates another practice wherein the anhydrous HCl byproduct streams from Steps (1) and (3) are combined process to form aqueous HCl which is then processed according to the invention. In FIG. 4, the HCl byproduct stream 401 from Step (1) comprises HCl, HF, various halogenated organic compounds in minor amounts including without limitation 1232xf, 1234yf, 244bb, 245cb and also 1233xf which makes up most of the contaminating organics in stream 401. Stream 401 is sent to HCl distillation column 402 which can comprise a series of such columns, and the overhead 403 is sent to HCl column condenser 404. The bottom liquid reflux 405 from condenser 404 is recycled to column 402. The bottoms 426 from distillation column 402 is sent to HCl column reboiler 426, the top stream from which 427 is recycled back to column 402, and the bottom stream from which 428 is essentially free of HCl but contains various organics which can be sent for further processing, including recovery (not shown). Similarly, the HCl byproduct stream 407 from Step (3) comprises HCl, minor amount of HF, various halogenated organic compounds also in minor amounts including without limitation TFPY, 1233xf, 244bb, and including 1234yf which makes up most of the contaminating organics in stream 407. Stream 407 is sent to HCl distillation column 408 which can comprise a series of such columns, and the overhead 409 is sent to HCl column condenser 410. The bottom liquid reflux 411 from condenser 410 is recycled to column 408. The bottoms 421 from distillation column 408 is sent to HCl column reboiler 422, the top stream from which 423 is recycled back to column 408, and the bottom stream from which 424 is essentially free of HCl but contains various organics which can be sent for further processing, including recovery (not shown).

Streams 406 and 412 coming respectively from condensers 404, associated with Step (1), and 410, associated with Step (3), are combined to form stream 413 which is fed to silica gel tower 414. Silica gel tower 414 can be a single tower or multiple towers in series or parallel. Tower 414, the use of which is optional in the practice of the present invention, principally removes trace HF still present in combined stream 413. Silica gels useful in this regard are as above. Effluent 415 from tower 414 is sent to HCl absorption system 416 to which water 417 is fed. Effluent 418, comprising aqueous HCl, is then sent to adsorbent bed 419, which can be a single adsorbent bed or multiple beds in series or parallel. Adsorbent bed 419 can comprise materials such as without limitation activated carbons, molecular sieves, including zeolites and HF molecular sieves such as silicalite, carbon molecular sieves, and combinations thereof, as above. The operating conditions for bed 419 are also as above. The conditions are effective for the adsorbent to remove sufficient amounts of fluorinated organics such as 1233xf, 1234yf and TFPY such that the HCl effluent 420 meets or can be further treated to meet specifications stipulated for sale as high purity or food grade HCl solution, including as a 22 Baume solution.

In an embodiment, a composition comprising hydrochloric acid (HCl) and at least one halogenated organic compound selected from the group consisting of trifluoropropyne (TFPY), 2-chloro-3,3,3-trifluoropropene (HCFO-1233xf), and 2,3,3,3-tetrafluoropropene (HFO-1234yf) is prepared by the present process, wherein a total amount of the halogenated organic compounds are present in an amount ranging from 0.1 ppm and 75 ppm, while in another embodiment, the total amount of halogenated organic compound is present in an amount ranging from 0.1 ppm to about 50 ppm, while in another embodiment, the total amount of halogenated organic compound is present in an amount ranging from 0.1 ppm and 25 ppm. In an embodiment, at least one of the halogenated organic compounds is present in an amount of 20 ppm or less, while in another embodiment, at least one of the halogenated organic compounds is present in an amount of 15 ppm or less, and in a further embodiment, at least one of the halogenated organic compounds is present in an amount of 10 ppm or less, and in a still further embodiment, at least one of the halogenated organic compounds is present in an amount of 5 ppm or less and in a further embodiment, at least one of the halogenated organic compounds is present in an amount of 2 ppm or less.

In an embodiment, the HCl prepared by the present process has 0 ppm 1234yf but has one or both of halogenated impurity from the above-mentioned impurities (TFPY or 1233 xf) therein, while in another embodiment, it has only one of the aforementioned halogenated organic compound impurities present therein. In another embodiment, the hydrochloric acid prepared by the present process contains 1234yf in an amount of at most 25 ppm, and in another embodiment, in an amount at most of 10 ppm and in another embodiment, in an amount at most 5 ppm.

In an embodiment, the hydrochloric acid prepared by the present process contains 1234yf in an amount ranging from 0.1 to 25 ppm, while in another embodiment, it contains 1234yf in an amount ranging from 0.1 ppm to about 10 ppm, while in still another embodiment, it contain 1234yf in an amount ranging from about 0.1 ppm to about 5 ppm. while still in another embodiment, 1234yf is present in an amount ranging from 2 ppm to 5 ppm.

In an embodiment, the HCl prepared by the present process has 0 ppm 1233xf but has one or both of the halogenated impurity from the above-mentioned impurities (1234yf or TFA) therein, while in another embodiment, it has only one of the aforementioned halogenated organic compound impurities present therein. In another embodiment, the hydrochloric acid prepared by the present process contains 1233xf in an amount of at most 25 ppm, and in another embodiment, in an amount at most 10 ppm and in another embodiment, in an amount at most 5 ppm.

In an embodiment, the hydrochloric acid prepared by the present process contains 1233f in an amount ranging from 0.1 to 25 ppm, while in another embodiment, it contains 1233xf in an amount ranging from 0.1 ppm to about 10 ppm, while in still another embodiment, it contain 1233xf in an amount ranging from about 0.1 ppm to about 5 ppm. while still in another embodiment, 1233xf is present in an amount ranging from 2 ppm to 5 ppm.

In an embodiment, the HCl prepared by the present process has 0 ppm TFPY but has one or both of the halogenated impurity from the above-mentioned impurities (1.234yf or 1233xf) therein, while in another embodiment, it has only one of the aforementioned halogenated organic compound impurities present therein. In another embodiment, the hydrochloric acid prepared by the present process contains TFPY in an amount of at most 25 ppm, and in another embodiment, in an amount at most of 10 ppm and in another embodiment, in an amount at most 5 ppm.

In an embodiment, the hydrochloric acid prepared by the present process contains TFPY in an amount ranging from 0.1 to 25 ppm, while in another embodiment, it contains TFPY in an amount ranging from 0.1 ppm to about 10 ppm, while in still another embodiment, it contain TFPY in an amount ranging from about 0.1 ppm to about 5 ppm. while still in another embodiment, TFPY is present in an amount ranging from 2 ppm to 4 ppm.

In an embodiment, the hydrochloric acid prepared by the present process has less of TFPY than HCFO-1233xf and HFO-1234yf, while in another embodiment, the hydrochloric acid prepared by the present process contain less of HCFO-1233xf than the TFPY and the HFO-1234yf, while in another embodiment, the hydrochloric acid prepared by the present process contains less than HFO-1234yf than the HCFO-1233xf or the TFPY. In another embodiment, the hydrochloric acid contain less of each of HCFO-1233xf and HFO-1234yf than TFPY, while in another embodiment, it contains less of each of HCFO-1233xf and TFPY than HFO-1234yf, while in another embodiment, it contains less of each TFPY and HFO-1234yf than HCFO-1233xf.

In an embodiment, the HCl composition of the present invention contains 5 ppm or less of HFO-1234yf, 5 ppm or less of TFPY and 0 ppm of HCFO-1233xf; nevertheless, it contain at least one of FIFO-1234yf or TFPY in an amount of 0.1 ppm o greater, within the limits described hereinabove.

As described herein, the HCl composition so prepared by the present process, can be mixed with water to prepare a HCl solution of about 20 to about 23 Baume; in another embodiment, it can be mixed with water to prepare a HCl solution ranging from about 21 Baume to about 23 Baume, such as about a 22 Baume solution.

In any of the compositions comprising HCl described herein, additional halogenated halocarbons may be present, such as HCFO-244bb or 1,1,1,2,2-pentafluoropropane (HFC-245cb) or a combination thereof.

The hydrochloric acid so prepared has an unique characteristic that is not present in other hydrochloric acid preparations. It has an internal marker of halogenated organic compounds. In other words, the hydrochloric acid prepared by the present method contains the minute quantities, in the amounts described hereinabove, of the halogenated organic compounds comprised of TFPY, HCFO-1233xf, or HFO-1234yf, or combination thereof of two or all three of TFPY, HCFO-1233xf, or HFO-1234yf. This has the advantage of identifying whether the process of making HCl were made by the process described herein. In other words, it acts as the identity o the origin of the hydrochloric acid so prepared.

The following examples further illustrate the present process.

### EXAMPLE 1

### Removal of 1234yf, CF₃CCH (trifluoropropyne), and 1233xf Included in HCl Over Activated Carbons

A cylindrical Monel reactor of ¾ diameter immersed into a 3-zone electrical furnace was used in all of the experiments of adsorption tests. Process temperatures were recorded using a multi-point thermocouple placed inside the reactor and within the catalyst bed. The distance between two adjacent probe points was 4″. A carbon adsorbent was loaded in such a way that its bed was within three adjacent probe points. The solid adsorbent was dried in nitrogen flow for 4 hours at 200° C. After drying step, the reactor was cooled down to room temperature (typically between 20 and 30° C.). Organic/HCl feed was then fed into the bottom of the vertically mounted reactor. Effluent gases were periodically taken into a de-ionized (D.I.) water loaded gas-bag to absorb the HCl. Then, certain amount of trans-1234ze product was added into the gas-bag as internal standard for quantification purpose. The vapor was analyzed for the levels of organics including 1234yf, trifluoropropyne, and 1233xf, which would be compared with that in the feed to determine the adsorption efficiency of each adsorbent. Table 1 lists the concentrations of three organic components before and after solid adsorbent bed and their change percentages.

TABLE 1*

| | Feed | 1234yf, | | CF₃CCH, | | 1233xf, | | | | |
|---|---|---|---|---|---|---|---|---|---|---|
| | rate, | ppm | | ppm | | ppm | | Change, % | | |
| Adsorbent | g/h | Before | After | Before | After | Before | After | 1234yf | CF₃CCH | 1233xf |
| Calgon | 19.2 | 126 | 0 | 117 | 4 | 135 | 0 | −100 | −97 | −100 |
| Carbon | | | | | | | | | | |
| (CPG-LF) | | | | | | | | | | |
| Calgon | 31.2 | 145 | 22 | 98 | 91 | 167 | 0 | −85 | −8 | −100 |
| Carbon | | | | | | | | | | |
| (PCB-LS) | | | | | | | | | | |
| Calgon | 24.1 | — | — | 3006 | 0 | — | — | — | −100 | — |
| Carbon | | | | | | | | | | |
| (OLC | | | | | | | | | | |
| 12 × 40) | | | | | | | | | | |

*All tests were run at room temperature and 1 atm over 50 ml of adsorbents

### EXAMPLE 2

### Removal of 1234yf, CF₃CCH(trifluoropropyne), and 1233xf Included in HCl Over Zeolites

A cylindrical Monel reactor of ¾″ diameter immersed into a 3-zone electrical furnace was used in all of the experiments of adsorption tests. Process temperatures were recorded using a multi-point thermocouple placed inside the reactor and within the catalyst bed. The distance between two adjacent probe points was 4″. A zeolite adsorbent was loaded in such a way that its bed was within three adjacent probe points. The solid adsorbent was dried in nitrogen flow for 4 hours at 200° C. After drying step, the reactor was cooled down to room temperature (typically between 20 and 30° C.). Organic/HCl feed was then fed into the bottom of the vertically mounted reactor. Effluent gases were periodically taken into a D.I. water loaded gas-bag to absorb the HCl. Then, certain amount of trans-1234ze product was added into the gas-bag as internal standard for quantification purpose. The vapor was analyzed for the levels of organics including 1234yf, trifluoropropyne, and 1233xf, which would be compared with that in the feed to determine the adsorption efficiency of each adsorbent. Table 2 lists the concentrations of three organic components before and after solid adsorbent bed and their change percentages.

TABLE 2*

| | Feed | 1234yf, | | CF₃CCH, | | 1233xf, | | | | |
|---|---|---|---|---|---|---|---|---|---|---|
| | rate, | ppm | | ppm | | ppm | | Change, % | | |
| Adsorbent | g/h | Before | After | Before | After | Before | After | 1234yf | CF₃CCH | 1233xf |
| MFI(550)-5 | 15.2 | 126 | 5 | 117 | 3 | 135 | 0 | −96 | −98 | −100 |
| (Na⁺- | | | | | | | | | | |
| silicalite) | | | | | | | | | | |
| MFI(300)-6 | 20.4 | 145 | 3 | 98 | 4 | 167 | 0 | −98 | −96 | −100 |
| (H⁺- | | | | | | | | | | |
| silicalite) | | | | | | | | | | |
| MFI(40)-6 | 38.3 | 126 | 64 | 117 | 114 | 135 | 0 | −50 | −3 | −100 |
| (H⁺ form | | | | | | | | | | |
| 13X | 17.0 | 145 | 139 | 98 | 98 | 167 | 156 | −4 | 0 | −7 |
| AW 500 | 18.4 | 145 | 96 | 98 | 98 | 167 | 13 | −34 | 0 | −92 |
| 5A | 13.7 | 145 | 102 | 98 | 98 | 167 | 13 | −4 | 0 | −92 |

*All tests were run at room temperature and 1 atm over 50 ml of adsorbents

Regeneration was conducted after reaching adsorption saturation over MFI(550)-5 by treating the used MFI(550)-5 adsorbent in nitrogen flow for 4 h at 200° C. After regeneration, the adsorption test was re-started. As shown in the same Table 3, the regenerated MFI(550)-5 behaved similarly as the fresh sample, indicating it is regenerable.

TABLE 3

| | Feed | 1234yf, | | CF₃CCH, | | 1233xf, | | | | |
|---|---|---|---|---|---|---|---|---|---|---|
| | rate, | ppm | | ppm | | ppm | | Change, % | | |
| Adsorbent | g/h | Before | After | Before | After | Before | After | 1234yf | CF₃CCH | 1233xf |
| Fresh | 15.2 | 126 | 5 | 117 | 3 | 135 | 0 | −96 | −98 | −100 |
| MF1(550)-5 | | | | | | | | | | |
| Regenerated | 13.8 | 126 | 2 | 117 | 2 | 135 | 0 | −98 | −99 | −100 |
| MFI(550)-5 | | | | | | | | | | |

### EXAMPLE 3

### Removal of CF₃CCH(trifluoropropyne) Included in HCl Over Carbon Molecular Sieves

A cylindrical Monel reactor of ¾ diameter immersed into a 3-zone electrical furnace was used in all of the experiments of adsorption tests. Process temperatures were recorded using a multi-point thermocouple placed inside the reactor and within the catalyst bed. The distance between two adjacent probe points was 4″. A CMS (carbon molecular sieve) adsorbent was loaded in such a way that its bed was within three adjacent probe points. The solid adsorbent was dried in nitrogen flow for 4 hours at 200° C. After drying step, the reactor was cooled down to room temperature (typically between 20 and 30° C.). TFPY/HCl feed was then fed into the bottom of the vertically mounted reactor. Effluent gases were periodically taken into a D.I. water loaded gas-bag to absorb the HCl. Then, certain amount of trans-1234ze product was added into the gas-bag as internal standard for quantification purpose. The vapor was analyzed for the level of TFPY (CF₃CCH or trffluoropropyne), which would be compared with that in the feed to determine the adsorption efficiency of each adsorbent. Table 4 lists the concentration of TFPY before and after solid adsorbent bed and its change percentage.

TABLE 4*

| | | Pore | Average | Feed | | | |
|---|---|---|---|---|---|---|---|
| | Surface | volume, | pore | rate, | CF₃CCH, ppm | | Change, % |
| Adsorbent | area, m²/g | ml/g | size, Å | g/h | Before | After | CF₃CCH |
| Shirasagi | 508 | 0.23 | 17.8 | 22.4 | 3006 | 1290 | −57 |
| X2M4/6 | | | | | | | |
| CMS H2 55/2 | 750 | 0.3 | 5 | 23.3 | 162 | 0 | −100 |
| Shirasagi CT- | 300 | 0.1 | 3 | 33.0 | 3006 | 3006 | 0 |
| 350 | | | | | | | |

*All tests were run at room temperature and 1 atm over 50 ml of adsorbents

As used herein the terms 2-chloro-3,3,3-trifluoropropene and HCFO-1233xf and 1233xf represent the same compound and are used interchangeably.

Further, the terms 2,3,3,3-tetrafluoropropene and HFO-1234yf and 1234yf represent the same compound and are used interchangeably.

The foregoing description is by way of example only and is not limiting to the scope of the invention.

1. A separation process comprising contacting a composition comprising hydrochloric acid (HCl) and trifluoropropyne (TFPY) with an adsorbent selected from activated carbon, MFI molecular sieve, carbon molecular sieve, silica, and combinations thereof, under conditions effective to separate the TFPY from the HCl.

2. The process of claim 1 wherein the composition further comprises 2-chloro-3,3,3-trifluoropropene (HCFO-1233xf), 2,3,3,3-tetrafluoropropene (HFO-1234yf), or mixtures thereof, and wherein the contacting is under conditions effective to separate the HCFO-1233xf and HFO1234yf from the HCl.

3. The process of claim 1 wherein TFPY is present in the composition at greater than 25 ppm by weight.

4. The process of claim 1 further comprising absorbing the HCl from which the TFPY has been separated into water under conditions effective to form solution wherein TFPY is present at 25 ppm by weight or less.

5. The process of claim 1 wherein the MFI molecular sieve is ZSM-5 or silicalite.

6. The process of claim 1 wherein the composition further comprises hydrogen fluoride (HF) and the process further comprises contacting the composition with silica prior to contacting the composition with said adsorbent, the contacting with silica under conditions effective to remove the HF.

7. A process for removing a halogenated organic from hydrochloric acid comprising
a) contacting a composition comprising hydrochloric acid (HCl), hydrogen fluoride (HF) and at least one halogenated organic with an adsorbent comprising silica under conditions effective to adsorb HF to produce a first composition comprising HCl and said at least one halogenated organic;
b) contacting the first composition with an adsorbent comprising activated carbon, zeolite molecular sieve, carbon molecular sieve, or combinations thereof, under conditions effective to adsorb the halogenated organic to produce a second composition comprising HCl.

8. The process of claim 7 further comprising contacting the second composition with water under conditions effective to absorb the HCl to produce an aqueous solution comprising HCl.

9. The process of claim 8 wherein the aqueous solution comprising HCl has a concentration of about 7 Baume to about 23 Baume.

10. (canceled)

11. (canceled)

12. The process of claim 7 wherein the halogenated organic is selected from TFPY, HCFO-1233xf, HFO-1234yf, 1232xf, 244bb, 245cb, or mixtures thereof.

13. The process for removing a halogenated organic from hydrochloric acid comprising
a) contacting a composition comprising hydrochloric acid (HCl), hydrogen fluoride (HF) and at least one halogenated organic with an adsorbent comprising silica under conditions effective to adsorb HF to produce a first composition comprising HCl and said at least one halogenated organic;
b) contacting the first composition with water under conditions effective to absorb the HCl to produce a second composition comprising an aqueous solution comprising HCl and said at least one halogenated organic;
c) contacting the second composition with adsorbent comprising activated carbon, zeolite molecular sieve, carbon molecular sieve, or combinations thereof, under conditions effective to adsorb the at least one halogenated organic to produce a third composition comprising HCl.

14. The process of claim 13 wherein the third composition comprising HCl has a concentration of about 7 Baume to about 23 Baume.

15. (canceled)

16. (canceled)

17. The process of claim 13 wherein the halogenated organic is selected from TFPY, HCFO-1233xf, HFO-1234yf, 1232xf, 244bb, 245cb, and mixtures thereof.

18. A separation process comprising contacting a composition comprising hydrochloric acid (HCl) and 2,3,3,3-tetrafluoropropene (HFO-1234yf) with an adsorbent selected from activated carbon, MFI molecular sieve, carbon molecular sieve, silica, and combinations thereof, under conditions effective to separate HFO-1234yf from the HCl.

19. The process of claim 18, wherein the adsorbent is activated carbon, which may optionally be granulated, or MFI molecular sieve.

20. (canceled)

21. (canceled)

22. The process of claim 18 where the activated carbon has a minimum Iodine number of 900.

23. (canceled)

24. (canceled)

25. (canceled)

26. (canceled)

27. The process of claim 18, further comprising producing HFO-1234yf and HCl from 2-chloro-1,1,1,2-tetrafluoropropane (HCFC-244bb).

28. A composition comprising hydrochloric acid (HCl) and at least one halogenated organic compound selected from the group consisting of trifluoropropyne (TFPY), 2-chloro-3,3,3-trifluoropropene (HCFO-1233xf), and 2,3,3,3-tetrafluoropropene (HFO-1234yf), a total amount of the halogenated organic compounds present in an amount between 0.1 ppm and 25 ppm and which may optionally additionally comprise 2-chloro-1,1,1,2-tetrafluoropropene (HCFO-244bb).

29. (canceled)

30. (canceled)

31. (canceled)

32. The composition of claim 28, wherein at least one of the halogenated organic compounds is present in an amount of 5 ppm or less.

33. (canceled)

34. The composition of claim 28, wherein the HFO-1234yf is present in an amount ranging from about 0.1 ppm to 5 ppm and TFPY is present in an amount of about 0.1 ppm to about 5 ppm.

35. (canceled)

36. (canceled)

37. (canceled)

38. (canceled)

39. (canceled)

40. (canceled)
